(19) United States
(12) Patent Application Publication
(10) Pub. No.: US 2018/0226808 A1
(43) Pub. Date: Aug. 9, 2018

(54) BATTERY MODULE BALANCING METHOD USING SINGLE INDUCTOR

(71) Applicant: POSTECH ACADEMY-INDUSTRY FOUNDATION, Pohang-si (KR)

(72) Inventors: Bong Koo KANG, Pohang-si (KR); Sang Won LEE, Daejeon-si (KR); Kyung Min LEE, Yongin-si (KR); Yoon Geol CHOI, Seoul (KR)

(21) Appl. No.: 15/886,102

(22) Filed: Feb. 1, 2018

(30) Foreign Application Priority Data
Feb. 2, 2017 (KR) 10-2017-0015095

(51) Int. Cl. H02J 7/00

(52) U.S. Cl. CPC H02J 7/0014; H02J 7/0021

(57) ABSTRACT

The present invention relates to a battery module balancing method using a single inductor.

The battery module balancing method can balance a plurality of battery cells using a single inductor in each of battery modules having modularized battery cells, and balance the plurality of modules using a single inductor. Thus, the battery module balancing method can reduce the number of balancing operations and raise balancing power, thereby improving balancing efficiency.

### BACKGROUND

### 1. Technical Field

The present disclosure relates to a battery module balancing technique using a single inductor, and more particularly, to a battery module balancing method using a single inductor, which can balance a plurality of battery cells using a single inductor in each of battery modules including modularized battery cells, and balance the plurality of battery modules using a single inductor, thereby reducing the number of balancing operations and raising balancing power to improve balancing efficiency.

### 2. Related Art

In general, when a voltage across a battery (battery cell) exceeds a predetermined value, the battery may explode. On the other hand, when the voltage across the battery falls below a predetermined value, the battery may suffer a permanent damage. Since a hybrid electric vehicle or notebook computer requires a relatively high-capacity power supply, the hybrid electric vehicle or notebook computer uses a battery module having battery cells connected in series, in order to supply power using battery cells. In this case, however, a voltage imbalance may occur due to a performance deviation among the battery cells.

For example, when one battery cell in the battery module reaches the upper-limit voltage before the other battery cells while the battery module is charged, the battery module cannot be charged any more. Therefore, the charging should be ended even though the other battery cells are not sufficiently charged. In this case, the charge capacity of the battery module may not reach the rated charge capacity.

On the other hand, when one battery cell within the battery module reaches the lower-limit voltage before the other battery cells while the battery module is discharged, the battery module cannot be used any more. Thus, the use time of the battery module is reduced as much.

Thus, when the battery cells are charged or discharged, the electrical energy of a battery cell having relatively high electrical energy can be supplied to another battery cell having relatively low electrical energy, in order to improve the use time of the battery module. Such an operation is referred to as battery cell balancing.

FIG. 1 illustrates a conventional battery cell balancing circuit using parallel resistors. As illustrated in FIG. 1, the battery cell balancing circuit includes a battery module 11 having battery cells CELL1 to CELL4 connected in series, resistors R11 to R14 connected in series, and switches SW11 to SW15 configured to selectively connect arbitrary terminals of the battery cells CELL1 to CELL4 to the corresponding terminals of the resistors R11 to R14.

Referring to FIG. 1, when a charging voltage of an arbitrary battery cell among the battery cells CELL1 to CELL4 within the battery module 11 reaches the upper-limit voltage before charging voltages of the other battery cells while the battery module 11 is charged, the corresponding switch among the switches SW11 to SW15 is turned on to discharge the arbitrary battery cell through the corresponding resistor among the resistors R11 to R14.

For example, when the charging voltage of the second battery cell CELL2 reaches the upper-limit voltage before the charging voltages of the other battery cells CELL1, CELL3 and CELL4, the switches SW12 and SW13 are turned on. Therefore, while the battery cell CELL2 is discharged through the resistor R12, battery cell balancing is achieved.

However, when such a battery cell balancing circuit is used, power is consumed through the resistors. Therefore, the efficiency is reduced as much. Furthermore, while the battery module is used, the upper-limit voltage cannot be supplied to a battery cell having a low voltage. Thus, the efficiency is inevitably reduced.

FIG. 2 illustrates another conventional battery cell balancing circuit using capacitors. As illustrated in FIG. 2, the battery cell balancing circuit includes a battery module 21 having battery cells CELL1 to CELL4 connected in series, capacitors C21 to C23 connected in series, and switches SW21 to S24 configured to selectively connect both terminals of the capacitors C21 to C23 to both terminals of the battery cells CELL1 to CELL3 or the battery cells CELL2 to CELL4.

Referring to FIG. 2, the battery cell balancing circuit using capacitors have two kinds of connection states. In the first connection state as illustrated in FIG. 2, both terminals of the capacitors C21 to C23 are connected to both terminals of the battery cells CELL1 to CELL3, respectively, through the switches SW21 to SW24. In the second connection state, both terminals of the capacitors C21 to C23 are connected to both terminals of the battery cells CELL2 to CELL4, respectively, through the switches SW21 to SW24.

In such a battery cell balancing circuit, however, a hard switching operation may occur between the capacitors and the battery cells, thereby degrading the efficiency. Preferably, the battery cells within the battery module may have the same capacity. However, the capacities of the battery cells differ from each other, due to various reasons. In this case, although any one battery cell has a lower charging voltage than the other battery cells, the battery cell may have a larger capacity. At this time, the voltage of the battery cell having a low voltage needs to be transferred to another battery cell having a high voltage. However, the conventional battery cell balancing circuit cannot perform such a voltage transfer function.

FIG. 3 illustrates another conventional battery cell balancing circuit using a flyback structure. As illustrated in FIG. 3, the battery cell balancing circuit using a flyback structure includes a battery module 31 having battery cells CELL1 to CELL4 connected in series, a flyback converter 32, switches SW31 to SW34 configured to selectively connect a plurality of secondary coils of the flyback converter 32 to both terminals of the battery cells CELL1 to CELL4, and a switch SW35 configured to selectively connect both terminals of a primary coil of the flyback converter 32 to both terminals of the battery module 31.

The battery cell balancing circuit of FIG. 3 is a battery cell balancing circuit using a flyback structure, which is one of switch mode power supply (SMPS) circuits. The battery cell balancing circuit can transfer electrical energy to the battery cells CELL1 to CELL4 connected in series in the battery module 31 using the switches SW31 to SW34, and transfer electrical energy between both terminals of the battery module 31.

Since the battery cell balancing circuit has the shape of the SMPS, the battery cell balancing circuit exhibits excellent efficiency. However, when the number of battery cells installed in the battery module is increased, the size of a magnetic core used in the flyback converter is increased. Thus, the price of the battery cell balancing circuit is inevitably raised.

Furthermore, when the plurality of battery cells are balanced through the conventional battery cell balancing circuits, the number of balancing operations is unnecessarily increased, and the amount of balancing power is low. Thus, the balancing efficiency is degraded.

### SUMMARY

Various embodiments are directed to a battery module balancing method using a single inductor, which can balance a plurality of battery cells using a single inductor in each of battery modules including modularized battery cells, and balance the plurality of battery modules using a single inductor, thereby improving balancing efficiency.

In an embodiment, a circuit to which a battery module balancing method using a single inductor is applied may include: a battery module pack having battery modules connected in series; a first-first access unit having access paths connected between one terminals of the battery modules and a first common node; a first-second access unit having access paths connected between the other terminals of the battery modules and a second common node; and a first electrical energy transfer unit having a single inductor and transfer paths in order to temporarily store electrical energy collected or supplied through the first and second common nodes and then transfer the stored electrical energy. Each of the battery modules may include a battery cell pack having battery cells connected in series; a second-first access unit having access paths connected between one terminals of the battery cells and a fifth common node; a second-second access unit having access paths connected between the other terminals of the battery cells and a sixth common node; and a second electrical energy transfer unit having a single inductor and transfer paths in order to temporarily store electrical energy collected or supplied through the fifth and sixth common nodes and then transfer the stored electrical energy.

In another embodiment, a battery module balancing method using a single inductor may include the steps: (a) preparing a battery module pack having M battery modules connected in series, a first access unit configured to access electrical energy of the battery modules, and a first electrical energy transfer unit having a first single inductor and transfer paths between the first access unit and the first single inductor in order to temporarily store the electrical energy accessed through the first access unit and transfer the temporarily stored electrical energy, wherein each of the battery modules has N battery cells connected in series, and includes a second access unit, a second single inductor Ls and a second electrical energy transfer unit, which are coupled to the respective battery cells through the same coupling structure as the first access unit, the first single inductor and the first electrical energy transfer unit; (b) measuring charges of all the battery cells in the battery modules once, checking whether a balancing operation condition is satisfied, sorting the charges of the battery cells when the balancing operation condition is satisfied, and calculating a target balanced charge on which the charges of the battery cells in the battery modules are to converge;(c) sorting balanced charges of the battery modules, and calculating a target balanced charge on which the charges of the battery modules are to converge; (d) selecting a strong cell and weak cell in the battery modules, and repetitively performing a balancing operation through the second access unit and the second electrical energy transfer unit, until the charges of the strong cell and the weak cell reach the target balanced charge on which the charges of the battery cells are to converge; and (e) selecting a strong module and weak module in the battery modules, and repetitively performing a balancing operation through the first access unit and the first electrical energy transfer unit, until the charges of the strong module and the weak module reach the target balanced charge on which the charges of the battery modules are to converge. The balancing operation may be performed inside and outside the modules at the same time, the N battery cells may perform (N−1) balancing operations, and the M modules may perform (M−1) balancing operations.

### BRIEF DESCRIPTION OF THE DRAWINGS

FIG. 1 illustrates a conventional battery cell balancing circuit using parallel resistors.

FIG. 2 illustrates another conventional battery cell balancing circuit using capacitors.

FIG. 3 illustrates another conventional battery cell balancing circuit using a flyback structure.

FIG. 4 is a circuit diagram to which a battery module balancing method using a single inductor according to an embodiment of the present invention is applied.

FIG. 5 is a circuit diagram of an arbitrary battery module among battery modules connected in series in a battery module pack of FIG. 4.

FIG. 6 is a table showing switch states in four kinds of cell access modes according to the embodiment of the present invention.

FIGS. 7A and 7B are flowcharts illustrating a battery module balancing method using a single inductor according to an embodiment of the present invention.

FIG. 8 is a diagram for describing a method for balancing a battery module pack using a single inductor.

FIGS. 9 and 10 are diagrams illustrating a balancing operation according to the embodiment of the present invention.

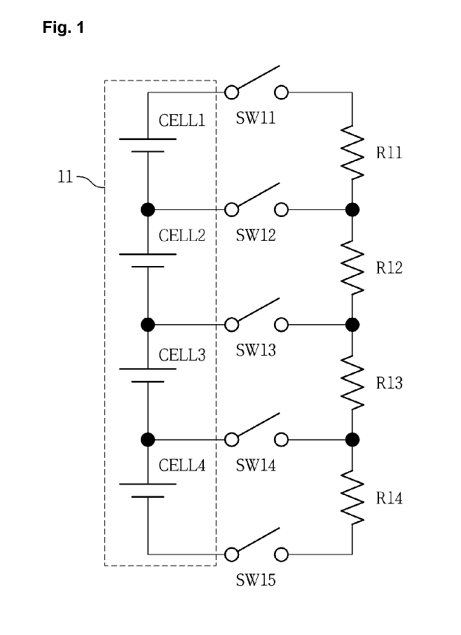

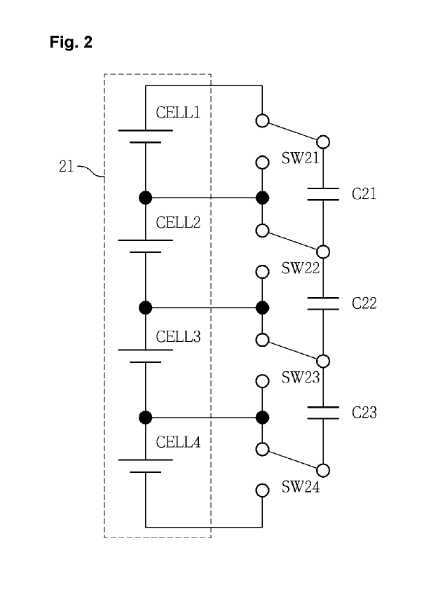

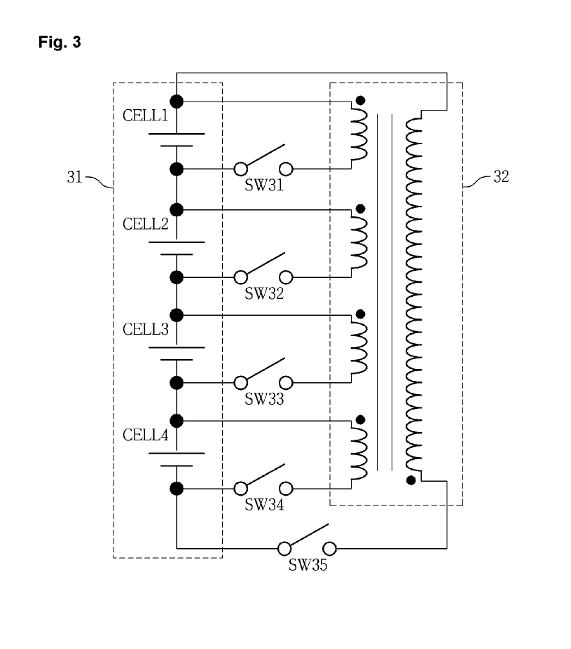

### DETAILED DESCRIPTION

Hereafter, embodiments of the present invention will be described in detail with reference to the accompanying drawings.

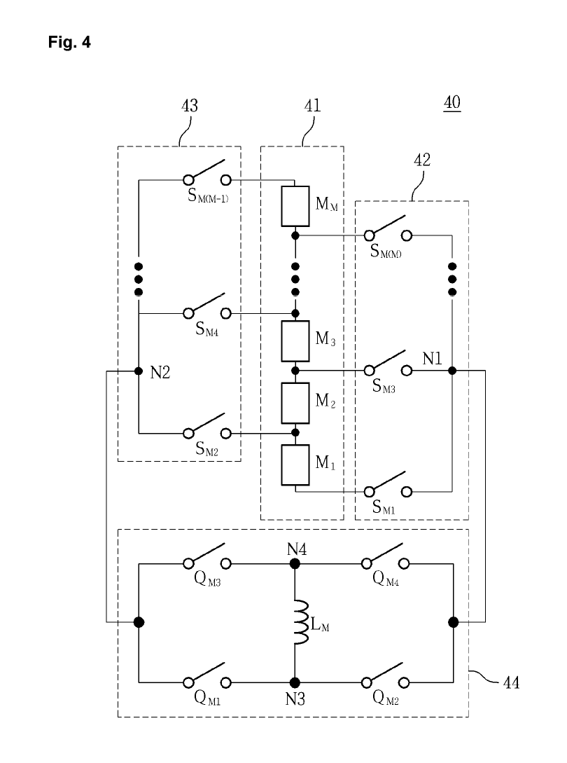

FIG. 4 is a circuit diagram to which a battery module balancing method using a single inductor according to an embodiment of the present invention is applied. As illustrated in FIG. 4, a battery module balancing circuit 40 includes a battery module pack 41, a first access unit and a first electrical energy transfer unit 44. The first access unit includes a first-first access unit 42 and a first-second access unit 43.

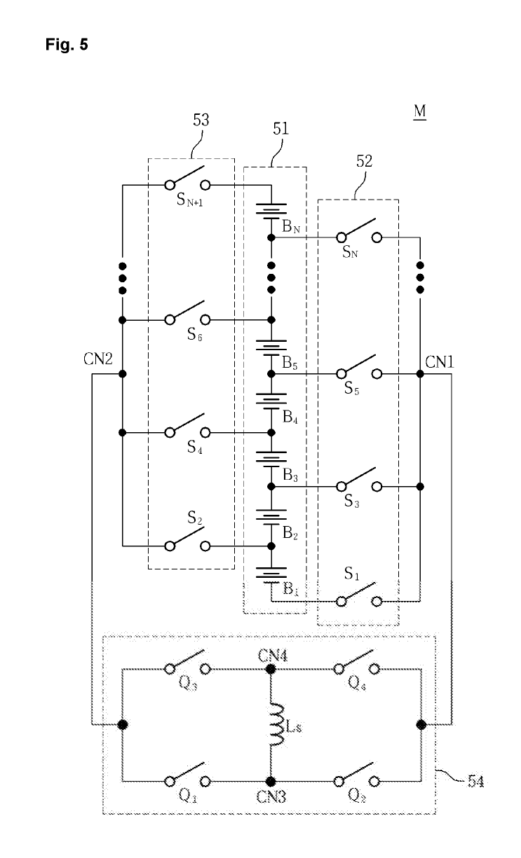

FIG. 5 is a circuit diagram illustrating an arbitrary battery module among battery modules M₁ to M_{M} connected in series in the battery module pack 41. As illustrated in FIG. 5, the battery module M includes a battery cell pack 51, a second access unit and a second electrical energy transfer unit 54. The second access unit includes a second-first access unit 52 and a second-second access unit 53

When the battery module balancing circuit 40 of FIG. is compared to the battery module M of FIG. 5, the battery module balancing circuit 40 and the battery module M are configured and operated in the same manner, except that the battery module balancing circuit 40 performs a balancing operation on the battery modules M₁ to M_{M} connected in series using a first single inductor L_{M}, and the battery module M performs a balancing operation on battery cells B₁ to B_{N} connected in series using a second single inductor Ls.

Thus, in the present embodiment, the balancing operation of the battery module M between the battery module balancing circuit 40 and the battery module M will be taken as an example for description.

The battery cell pack 51 includes the battery cells B₁ to B_{N} connected in series to store electrical energy supplied from outside. At this time, performance deviations among the battery cells B₁ to B_{N} may cause a voltage imbalance. However, the voltage imbalance is removed by a battery cell balancing operation which will be described below.

The second-first access unit 52 includes odd switches S₁ to S_{N} connected between a fifth common node N5 and negative terminals (“−” terminals) of the odd battery cells among the battery cells B₁ to B_{N} installed in the battery cell pack 51, in order to access electrical energy.

The second-second access unit 53 includes even switches S₂ to S_{N+1} connected between a sixth common node N6 and positive terminals (“+” terminals) of the even battery cells among the battery cells B₁ to B_{N} installed in the battery cell pack 51, in order to access electrical energy.

The second electrical energy transfer unit 54 includes four switches Q₁ to Q₄ and a second single inductor Ls, and serves to temporarily store electrical energy collected or discharged through the fifth and sixth common nodes N5 and N6, and then discharge the temporarily stored electrical energy.

Among the four switches Q₁ to Q₄, the switch Q₁ is connected between the sixth common node N6 and a seventh common node N7, the switch Q₂ is connected between the fifth common node N5 and the seventh common node N7, the switch Q₃ is connected between the sixth common node N6 and an eighth common node N8, and the switch Q₄ is connected between the fifth common node N5 and the eighth common node N8.

The second single inductor Ls is a single inductor serving as an electrical energy transfer medium, and serves to temporarily store the electrical energy collected from the battery cell pack 51 and discharge the temporarily stored electrical energy, in order to perform battery balancing on the battery cell pack 51. For this operation, the second single inductor Ls is connected between the eighth common node N8 and the seventh common node N7.

In FIG. 5, the switches S₁ to S_{N+1} of the second-first and second-second access units 52 and 53 and the switches Q₁ to Q₄ of the second electrical energy transfer unit 54 are not limited to a specific type, but may be implemented with power switches such as a metal oxide semiconductor field effect transistor (MOSFET), a bipolar junction transistor (BJT) and an insulated gate bipolar transistor (IGBT).

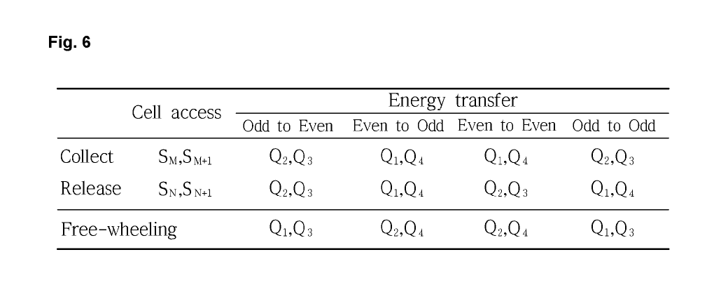

The battery module M is operated in four kinds of cell access modes, and each of the four kinds of cell access modes includes three kinds of driving modes (driving cycles). FIG. 6 shows the states of the switches S₁ to S_{N+1} of the second-first and second-second access units 52 and and the switches Q₁ to Q₄ of the electrical energy transfer unit 54 in the four kinds of cell access modes. In FIG. 6, a collect mode indicates a mode for collecting electrical energy from a strong cell which has relatively high electrical energy and discharges electrical energy, and a release mode indicates a mode for supplying electrical energy to a weak cell having relatively low electrical energy, the electrical energy being collected through the collector mode and temporarily stored in the second single inductor Ls.

The four kinds of cell access modes are classified into an odd-to-even mode, even-to-odd mode, even-to-even mode and odd-to-odd mode, depending on the parities of strong and weak cells between two battery cells selected as a battery cell balancing target, when battery cell balancing is performed on the battery cells B₁ to B_{N} installed in the battery cell pack 51.

The battery cell balancing path according to the embodiment of the present invention may be divided into two kinds of paths having different electrical energy flow paths. One of the two paths corresponds to a path when the strong cell and the weak cell have different parities, that is, in the odd-to-even mode and the even-to-odd mode (hereafter, referred to as “different parity path”). In the battery cell balancing mode using the different parity path, electrical energy collected from the strong cell is stored in the second single inductor Ls and then supplied to the weak cell. The other path of the two paths corresponds to a path when the strong cell and the weak cell have the same parity, that is, in the odd-to-odd mode and the even-to-even mode (hereafter, referred to as “same parity path”). In the battery cell balancing mode using the same parity path, electrical energy collected from the strong cell is stored in the second single inductor Ls and then supplied to the weak cell.

For reference, S_{M} and S_{M+1} in Cell access of FIG. 6 represent switches for accessing an M-th storing cell. For example, when the second battery cell B₂ is a strong cell, the switch S₂ corresponds to the switch S_{M}, and the switch S₃ corresponds to the switch S_{M+1}. Furthermore, S_{N} and S_{N+1} represent switches for accessing an N-th weak cell. For example, when the fourth battery cell B₄ is a weak cell, the switch S₄ corresponds to the switch S_{N}, and the switch S₅ corresponds to the switch S_{N+1}.

First, a battery cell balancing operation using the different parity path to supply electrical energy stored in an odd battery cell to an even battery cell will be described as follows. At this time, suppose that the odd battery cell B₁ is a strong cell, and the even battery cell B₄ is a weak cell.

In the first mode, a control unit (not illustrated) outputs a switch control signal (gate signal) to the switch S₁ of the second-first access unit 52, the switch S₂ of the second-second access unit 53 and the switches Q₂ and Q₃ of the second electrical energy transfer unit 54, and turns on the switches. Therefore, the positive terminal (+) of the battery cell B₁ is connected to one side of the second single inductor Ls through the switches S₂ and Q₃, and the negative terminal (−) of the battery cell B₁ is connected to the other side of the second single inductor Ls through the switches S₁ and Q₂. Thus, the electrical energy of the battery cell B₁ is transferred and stored into the second single inductor Ls.

When the weak cell is connected to the second single inductor Ls through the switches in the release mode after the strong cell is connected to the second single inductor Ls through the switches in the collect mode, a dead time is required between the collect mode and the release mode.

The second mode indicates a mode for forming an electrical energy circulation path during the dead time. For this mode, the switches Q₁ and Q₃ of the second electrical energy transfer unit 54 are turned on. Therefore, the previously collected electrical energy free-wheels in a closed loop composed of the switches Q₁ and Q₃ and the second single inductor Ls during the dead time.

The third mode indicates a mode for transferring the collected electrical energy to the battery cell B₄ set to the weak cell. For this mode, the control unit outputs the switch control signal to the switch S₅ of the second-first access unit 52, the switch S₄ of the second-second access unit 53 and the switches Q₂ and Q₃ of the second electrical energy transfer unit 54, and turns on the switches. Therefore, the electrical energy stored in the second single inductor Ls is transferred to the battery cell B₄ through the switches Q₂ and S₅.

Within one preset cycle, the first to third modes are repeated to equalize the voltage levels of the strong cell B₁ and the weak cell B₄.

Second, a battery cell balancing operation using the different parity path to supply electrical energy stored in an even battery cell to an odd battery cell will be described as follows. At this time, suppose that the even battery cell B₄ is a strong cell, and the odd battery cell B₁ is a weak cell.

In the first mode, the control unit outputs the switch control signal (gate signal) to the switch S₅ of the second-first access unit 52, the switch S₄ of the second-second access unit 53 and the switches Qᵢ and Q₄ of the second electrical energy transfer unit 54, and turns on the switches. Therefore, the positive terminal (+) of the battery cell B₄ is connected to one side of the second single inductor Ls through the switches S₅ and Q₄, and the negative terminal (−) of the battery cell B₄ is connected to the other side of the second single inductor Ls through the switches S₄ and Q₁. Thus, the electrical energy of the battery cell B₄ is transferred and stored into the second single inductor Ls.

When the weak cell is connected to the second single inductor Ls through the switches in the release mode after the strong cell is connected to the second single inductor Ls through the switches in the collect mode, a dead time is required between the collect mode and the release mode.

The second mode indicates a mode for forming an electrical energy circulation path during the dead time. For this mode, the switches Q₂ and Q₄ of the second electrical energy transfer unit 54 are turned on. Therefore, the previously collected electrical energy free-wheels in a closed loop composed of the switches Q₂ and Q₄ and the second single inductor Ls during the dead time.

The third mode indicates a mode for transferring the collected electrical energy to the battery cell B₁ set to the weak cell. For this mode, the control unit outputs the switch control signal to the switch S₁ of the second-first access unit 52, the switch S₂ of the second-second access unit 53 and the switches Q₁ and Q₄ of the second electrical energy transfer unit 54, and turns on the switches. Therefore, the electrical energy stored in the second single inductor Ls is transferred to the battery cell B₄ through the switches Q₁ and S₂.

Within one preset cycle, the first to third modes are repeated to equalize the voltage levels of the strong cell B₄ and the weak cell B₁.

Third, a battery cell balancing operation using the same parity path to supply electrical energy stored in an even battery cell to another even battery cell will be described as follows. At this time, suppose that the even battery cell B₄ is a strong cell, and the even battery cell B₂ is a weak cell.

In the first mode, the control unit outputs the switch control signal (gate signal) to the switch S₅ of the second-first access unit 52, the switch S₄ of the second-second access unit 53 and the switches Q₁ and Q₄ of the second electrical energy transfer unit 54, and turns on the switches. Therefore, the positive terminal (+) of the battery cell B₄ is connected to one side of the second single inductor Ls through the switches S₅ and Q₄, and the negative terminal (−) of the battery cell B₄ is connected to the other side of the second single inductor Ls through the switches S₄ and Q₁. Thus, the electrical energy of the battery cell B₄ is transferred and stored into the second single inductor Ls.

When the weak cell is connected to the second single inductor Ls through the switches in the release mode after the strong cell is connected to the second single inductor Ls through the switches in the collect mode, a dead time is required between the collect mode and the release mode.

The second mode indicates a mode for forming an electrical energy circulation path during the dead time. For this mode, the switches Q₂ and Q₄ of the second electrical energy transfer unit 54 are turned on. Therefore, the previously collected electrical energy free-wheels in a closed loop composed of the switches Q₂ and Q₄ and the second single inductor Ls during the dead time.

The third mode indicates a mode for transferring the collected electrical energy to the battery cell B₂ set to the weak cell. For this mode, the control unit outputs the switch control signal to the switch S₃ of the second-first access unit 52, the switch S₂ of the second-second access unit 53 and the switches Q₂ and Q₃ of the second electrical energy transfer unit 54 and turns on the switches. Therefore, the electrical energy stored in the second single inductor Ls is transferred to the battery cell B₂ through the switches Q₂ and S₃.

Within one preset cycle, the first to third modes are repeated to equalize the voltage levels of the strong cell B₄ and the weak cell B₂.

Fourth, a battery cell balancing operation using the same parity path to supply electrical energy stored in an odd battery cell to another odd battery cell will be described as follows. At this time, suppose that the odd battery cell B₁ is a strong cell, and the odd battery cell B₃ is a weak cell.

In the first mode, the control unit outputs the switch control signal (gate signal) to the switch S₁ of the second-first access unit 52, the switch S₂ of the second-second access unit 53 and the switches Q₂ and Q₃ of the second electrical energy transfer unit 54 and turns on the switches. Therefore, the positive terminal (+) of the battery cell B₁ is connected to one side of the second single inductor Ls through the switches S₂ and Q₃, and the negative terminal (−) of the battery cell B₁ is connected to the other side of the second single inductor Ls through the switches S₁ and Q₂. Therefore, the electrical energy of the battery cell B₁ is transferred and stored into the second single inductor Ls.

When the weak cell is connected to the second single inductor Ls through the switches in the release mode after the strong cell is connected to the second single inductor Ls through the switches in the collect mode, a dead time is required between the collect mode and the release mode.

The second mode indicates a mode for forming an electrical energy circulation path during the dead time. For this mode, the switches Q₁ and Q₃ of the second electrical energy transfer unit 54 are turned on. Therefore, the collected electrical energy free-wheels in a closed loop composed of the switches Q₁ and Q₃ and the second single inductor Ls during the dead time.

The third mode indicates a mode for transferring the collected electrical energy to the battery cell B₃ set to the weak cell. For this mode, the control unit outputs the switch control signal to the switch S₃ of the second-first access unit 52, the switch S₄ of the second-second access unit 53 and the switches Q₁ and Q₄ of the second electrical energy transfer unit 54 and turns on the switches. Therefore, the electrical energy stored in the second single inductor Ls is transferred to the battery cell B₂ through the switches Q₁ and S₄.

Within one preset cycle, the first to third modes are repeated to equalize the voltage levels of the strong cell B₁ and the weak cell B₃.

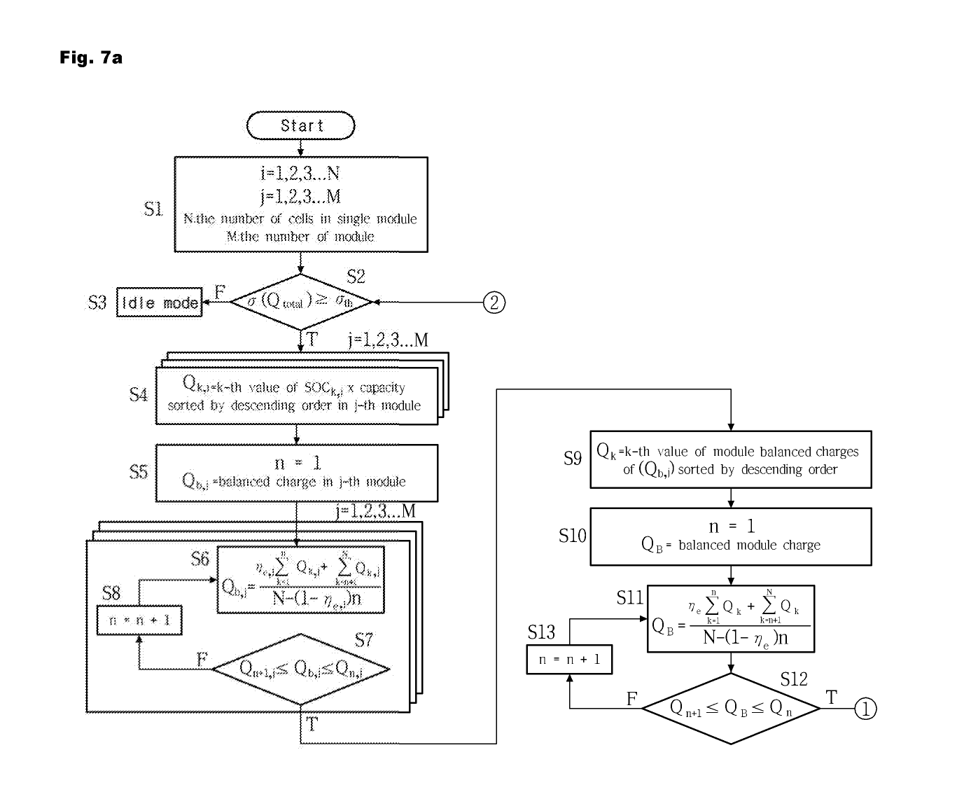

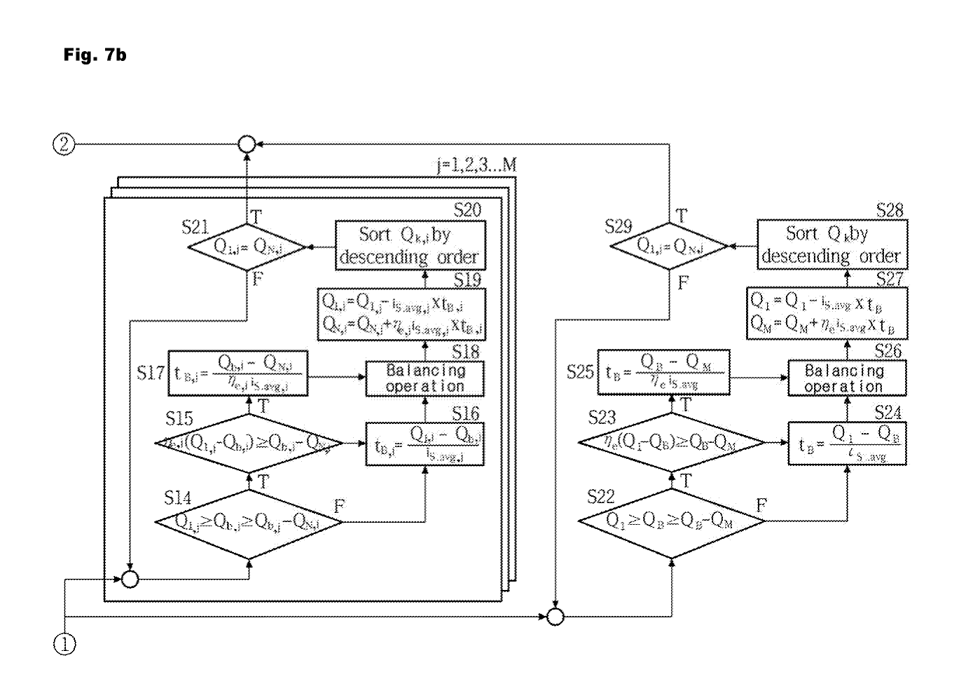

FIGS. 7A and 7B are flowcharts illustrating a battery module balancing method using a single inductor according to another embodiment of the present invention. As illustrated in FIGS. 7A and 7B, the battery module balancing method includes: preparing a battery module balancing circuit using a single inductor (S1 to S3); calculating a target balanced charge among battery cells in battery modules (S4 to S8); calculating a target balanced charge among the battery modules (S9 to S13); repetitively performing a balancing operation on the battery cells within the battery modules (S14 to S21); and repetitively performing a balancing operation on the battery modules (S22 to S29).

Before the battery module balancing method using a single inductor in FIGS. 7A and 7B is described, the battery module balancing method according to the present embodiment may be described as follows.

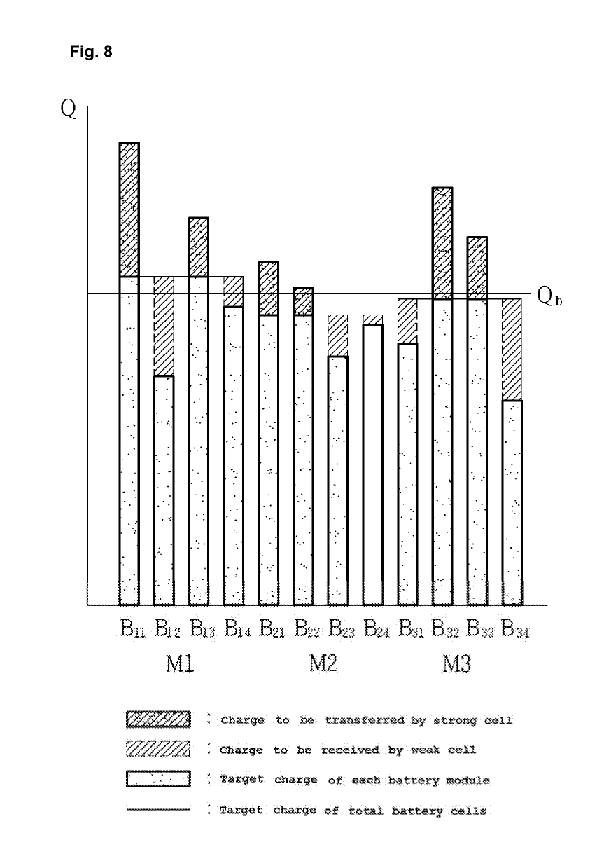

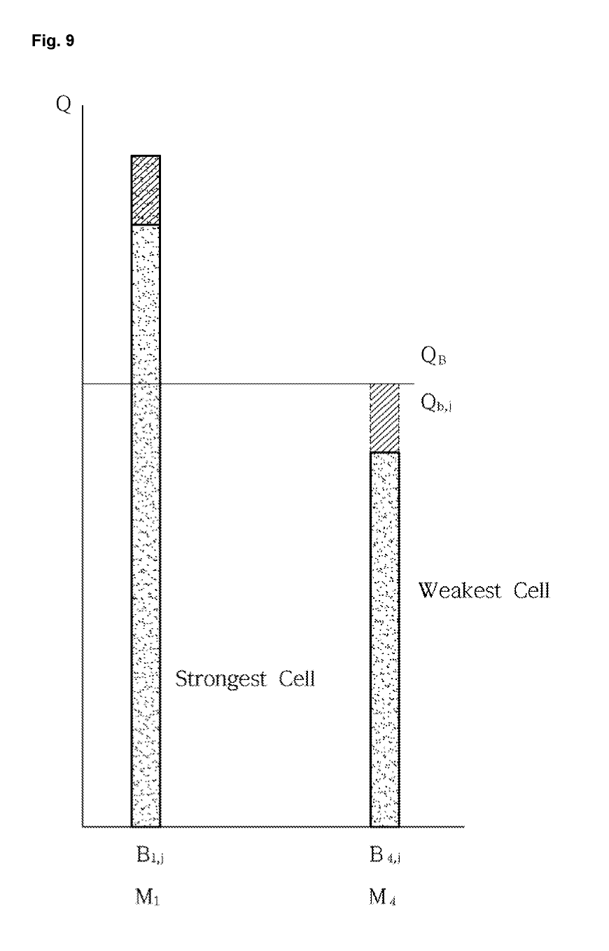

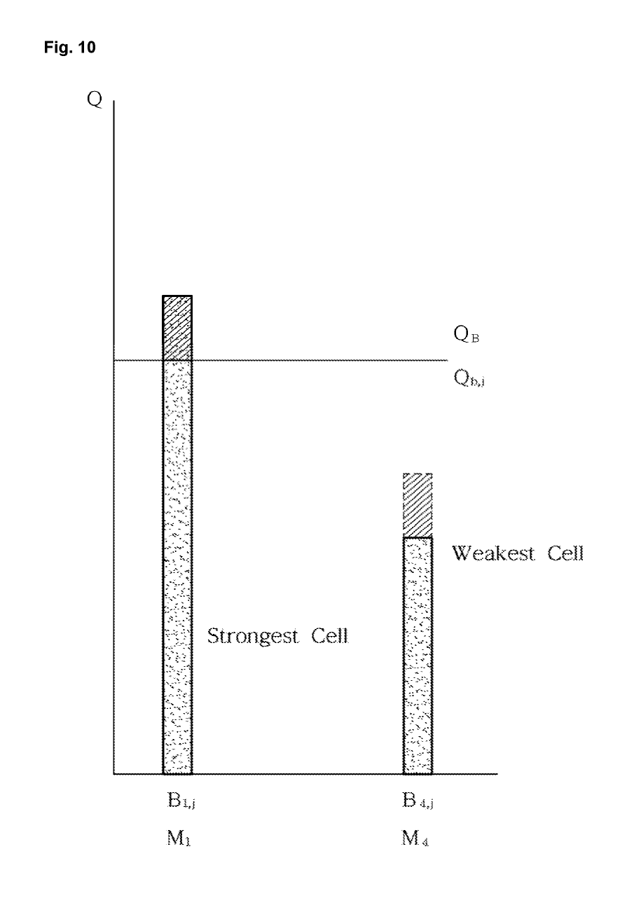

FIG. 8 is a diagram for describing a method for balancing a battery module pack 41 using a first single inductor L_{M}, the battery module pack 41 including modularized battery modules M₁ to M_{M} connected in series and each having N battery cells connected in series. FIG. 9 is a diagram illustrating that a balancing operation is performed only until a charge of a weak cell (module) reaches a target balanced charge Q_{b,j} (Q_{B}), when the charge of the weak cell (module) is closer to the target balanced charge Q_{b,j} (Q_{B}) than a charge of a strong cell (module). FIG. 10 is a diagram illustrating that a balancing operation is performed only until a charge of a strong cell (module) reaches the target balanced charge Q_{b,j} (Q_{B}), when the charge of the strong cell (module) is closer to the target balanced charge Q_{b,j} (Q_{B}) than a charge of a weal cell (module). Here, the target balanced charge Q_{b,j} (QB) indicates a target balanced charge on which the charges of all the cells or modules need to converge.

Referring to FIGS. 4, 5, and 7 to 10, the battery module balancing method using a single inductor according to the present embodiment will be described as follows.

In the battery module balancing method using a single inductor according to the present embodiment, balancing is performed as illustrated in FIGS. 4 and 5. As illustrated in FIG. 8, the battery module pack 41 includes three battery modules M₁ to M₃ and each of the battery modules M₁ to M₃ includes n strong cells having a larger amount of charge than a target balanced charge Q_{b} and (4−n) weak cells having a smaller amount of charge than the target balanced charge Q_{b}. When a residual charge of the strong cell is transferred to the weak cells, the charge may be transferred at an efficiency of ηₑ, for example. In this case, the charge may be expressed as Equation 1 below. In Equation 1, j represents a j-th battery module among the M battery modules. When three battery modules M₁ to M₃ are installed in the battery module pack 41 as described above, j may range from 1 to 3 (M).

$$( {\sum }_{k = 1}^{n} ( {Q}_{k , j} - {Q}_{b , j} ) ) \times {η}_{e , j} = {\sum }_{k = n + 1}^{4} ( {Q}_{b , j} - {Q}_{k , j} ) \qquad [ Equation 1 ]$$

The target balanced charge Q_{b,j} of the j-th battery module, which satisfies the balancing conditions of all battery cells using Equation 1, is expressed as Equation 2 below.

$${Q}_{b , j} = \frac{{\sum }_{k = 1}^{n} {Q}_{k , j} \times {η}_{e , j} + {\sum }_{k = n + 1}^{4} {Q}_{k , j}}{4 - ( 1 - {η}_{e , j} ) \times n} \qquad [ Equation 2 ]$$

That is, when the charges of the battery cells in the j-th battery module and the transfer efficiency of the balancing circuit are known, the target balanced charge Q_{b,j} of the battery cells in the j-th battery module can be calculated.

Then, based on the balanced charges of the total M battery modules, the final target balanced charge Q_{B} of all battery modules can be calculated in the same manner as the target balanced charge Q_{b,j}, and expressed as Equation 3 below.

$${Q}_{B} = \frac{{\sum }_{k = 1}^{n} {Q}_{k} \times {η}_{e} + {\sum }_{k = n + 1}^{3} {Q}_{k}}{3 - ( 1 - {η}_{e} ) \times n} \qquad [ Equation 3 ]$$

As such, the target balanced charge Q_{b,j} of the N battery cells in each of the battery modules is calculated through Equations 1 and 2, and the target balanced charge Q_{B} of the M battery modules is calculated through Equation 3.

The balancing operation among the N battery cells in the battery module using the target balanced charge Q_{b,j} and the balancing operation among the M battery modules using the target balanced charge Q_{B} are divided into two kinds of balancing operations.

FIG. 9 illustrates that one of the two kinds of balancing operations is performed. That is, when a difference between the charge of the weak cell and the target balanced charge Q_{b,j} is smaller than a difference between the charge of the strong cell and the target balanced charge Q_{b,j}, a balancing operation using a residual charge of the strong cell is performed until the charge of the weak cell reaches the target balanced charge Q_{b,j}. Similarly, when a difference between the charge of the weak module and the target balanced charge Q_{B} is smaller than a difference between the charge of the strong module and the target balanced charge Q_{B}, a balancing operation using a residual charge of the strong module is performed until the charge of the weak module reaches the target balanced charge Q_{B}.

FIG. 10 illustrates that the other of the two kinds of balancing operations is performed. That is, when a difference between the charge of the strong cell and the target balanced charge Q_{b,j} is smaller than a difference between the charge of the weak cell and the target balanced charge Q_{b,j}, a balancing operation using a residual charge of the strong cell is performed until the charge of the strong cell reaches the target balanced charge Q_{b,j}. Similarly, when a difference between the charge of the strong module and the target balanced charge Q_{B} is smaller than a difference between the charge of the weak module and the target balanced charge Q_{B}, a balancing operation using a residual charge of the strong module is performed until the charge of the strong module reaches the target balanced charge Q_{B}.

Hereafter, the battery module balancing method using a single inductor will be described with reference to FIGS. 7A and 7B.

First, the battery module balancing circuit using a single inductor, which has the configuration of FIG. 4, is prepared at step S1. For example, the battery module balancing circuit may include i battery cells and j battery modules where i is a natural number from 1 to N and j is a natural number from 1 to M.

The battery module balancing circuit measures charges of all battery cells in the M battery modules, and compares the measured charges to a predetermined threshold standard deviation σₜₕ, at step S2.

When all of the charges are less than the threshold standard deviation σₜₕ, the battery module balancing circuit determines that balancing has been achieved, and proceeds to an idle mode. On the other hand, when one or more of the charges are equal to or more than the threshold standard deviation σₜₕ, the battery module balancing circuit proceeds to a balancing operation mode, at step S3.

Then, in order to calculate the target balanced charge Q_{b,j} of the battery cells in the j-th battery module, the battery module balancing circuit sorts the charges of the N battery cells in the M battery modules by descending order at step S4.

When n strong cells are present in the M battery modules, the target balanced charge Q_{b,j} is positioned between the charge Q_{n,j} of the n-th battery cell to the charge Q_{n-1,j} of the (n+1)th battery cell. Specifically, while increasing n one by one, the battery module balancing circuit may calculate the charge of the corresponding battery cell. When the calculated charge is determined to be between the charges Q_{n,j} and Q_{n+,j}, the battery module balancing circuit sets the calculated charge to the target balanced charge Q_{n,j} in the corresponding battery module. The battery module balancing circuit calculates all of the j-th target balanced charges Q_{b,j} in the M battery modules in parallel, at steps S5 to S8.

Then, in order to calculate the final target balanced charge Q_{B} of all the battery modules, the battery module balancing circuit sorts the target balanced charges Q_{b,j} of the M battery modules by descending order, and then calculates the target balanced charges Q_{B} of the M battery modules through the same calculation process as the above-described calculation process (S5 to S8), at steps S9 to S13.

After calculating the target balanced charges Q_{b,j} in the respective M battery modules and the target balanced charge Q_{B} of the M battery modules through the above-described steps, the battery module balancing circuit performs a balancing operation. At this time, since the charges of the battery cells were sorted by descending order, the battery cell or battery module having the highest charge Q_{1,j} (Q₁) becomes the strong cell or strong module, and the battery cell or battery module having the n-th charge Q_{N,j} (Q_{M}) corresponding to the lowest charge becomes the weak cell or weak module.

When η_{e,j} (Q_{1,j}−Q_{b,j}) obtained by multiplying (Q_{1,j}−Q_{b,j}) by the efficiency is larger than (Q_{b,j}−Q_{N,j}), the battery module balancing circuit determines that the charge of the weak cell is closer to the target balanced charge Q_{b,j} than the charge of the strong cell as illustrated in FIG. 9. Otherwise, the battery module balancing circuit determines that the charge of the weak cell is farther from the target balanced charge Q_{b,j} than the charge of the strong cell as illustrated in FIG. 10, at steps S14 and S15.

Then, the battery module balancing circuit sets a balancing time t_{B,j} to perform a balancing operation, at steps S16 to S18. The balancing time t_{B,j} is calculated by dividing the total amount of charge to be transferred by the received average current. When a difference between the charge of the weak cell and the target balanced charge Q_{b,j} is larger than a difference between the charge of the strong cell and the target balanced charge Q_{b,j}, the battery module balancing circuit calculates the balancing time through Equation 4 below. When the difference between the charge of the weak cell and the target balanced charge Q_{b,j} is smaller than the difference between the charge of the strong cell and the target balanced charge Q_{b,j}, the battery module balancing circuit calculates the balancing time through Equation 5 below. Then, the battery module balancing circuit performs a balancing operation according to the balancing time t_{B,j}.

$$\begin{matrix}{t}_{B , j} = \frac{{Q}_{b , j} - {Q}_{N , j}}{{n}_{e , j} {i}_{S . avg , j}} & [ Equation 4 ] \\ {t}_{B , j} = \frac{{Q}_{1 , j} - {Q}_{b , j}}{{i}_{S . avg , j}} & [ Equation 5 ]\end{matrix}$$

Here, i_{S.avg,j} represents the average balancing current of the strong cell. When the average balancing current is transferred at an efficiency of η_{e,j} and received by the weak cell, the average balancing current becomes η_{e,j}i_{S.avg,j}.

After the balancing operation, the battery module balancing circuit recalculates the charges of the strong cell and the weak cell. At this time, a charge change corresponds to a value obtained by multiplying the balancing current by the balancing time t_{B,j}, and the charges Q_{1,j} and Q_{N,j} of the strong cell and the weak cell are updated as expressed by Equation 6 below, at step S19.

Q_{i,j}=Q_{i,j}−i_{S.avg,j}×t_{B,j}

Q_{N,j}=Q_{N,j}+η_{e,j}i_{S.avg,j}×t_{B,j} [Equation 6]

In this state, the battery module balancing circuit sorts the charges of the battery cells by descending order at step S20. At this time, represents the charge of the strong cell, and Q_{N,j} represents the charge of the weak cell.

When it is determined that a difference between the charges Q_{1,j} and Q_{N,j} is equal to or more than a preset value, the battery module balancing circuit repeats the series of steps S14 to S20. When it is determined that the difference falls within the preset value, the battery module balancing circuit returns to step S2, at step S21.

While performing a balancing operation on the battery cells B₁ to B_{N} in the battery modules M₁ to M_{M} through the series of steps S14 to S21, the battery module balancing circuit simultaneously performs a balancing operation on the battery modules M₁ to M_{M} in the same manner, at steps S22 to S29.

That is, when ηₑ (Q₁−Q_{B}) obtained by multiplying (Q₁−Q_{B}) by the efficiency is larger than (Q_{B}−Q_{M}), the battery module balancing circuit determines that the charge of the weak module is closer to the target balanced charge Q_{B} than the charge of the strong module. Otherwise, the battery module balancing circuit determines that the charge of the weak module is farther from the target balanced charge Q_{B} than the charge of the strong module, at steps S22 and S23.

Then, the battery module balancing circuit sets the balancing time t_{B} to perform a balancing operation at steps S24 to S26. The balancing time t_{B} is calculated by dividing the total amount of charge to be transferred by the received average current. When a difference between the charge of the weak module and the target balanced charge Q_{B} is larger than a difference between the charge of the strong module and the target balanced charge Q_{B}, the battery module balancing circuit calculates the balancing time through Equation 7 below. When the difference between the charge of the weak module and the target balanced charge Q_{B} is smaller than the difference between the charge of the strong module and the target balanced charge Q_{B}, the battery module balancing circuit calculates the balancing time through Equation 8 below. Then, the battery module balancing circuit performs a balancing operation according to the balancing time t_{B}.

$$\begin{matrix}{t}_{B} = \frac{{Q}_{B} - {Q}_{M}}{{n}_{e} {i}_{S . avg}} & [ Equation 7 ] \\ {t}_{B} = \frac{{Q}_{1} - {Q}_{B}}{{i}_{S . avg}} & [ Equation 8 ]\end{matrix}$$

Here, i_{S.avg} represents the average balancing current of the strong module. When the average balancing current is transferred at an efficiency of η_{e,j} and received by the weak module, the average balancing current becomes η_{e,j}i_{S.avg}.

After the balancing operation, the battery module balancing circuit recalculates the charges of the strong module and the weak module. At this time, a charge change corresponds to a value obtained by multiplying the balancing current by the balancing time t_{B}, and the charges Q₁ and Q_{M} of the strong module and the weak module are updated as expressed by Equation 9 below, at step S27.

Q₁=Q₁−i_{S.avg}×t_{B}

Q_{M}=Q_{M}+ηₑi_{S.avg}×t_{B} [Equation 9]

In this state, the battery module balancing circuit sorts the charges of the battery modules by descending order at step S28. At this time, Q₁ represents the charge of the strong module, and Q_{M} represents the charge of the weak module.

When it is determined that a difference between the charges Q₁ and Q_{M} is equal to or more than a preset value, the battery module balancing circuit repeats the series of steps S22 to S29. When it is determined that the difference falls within the preset value, the battery module balancing circuit returns to step S2, at step S29.

Such a balancing method may be applied to not only the balancing circuit of FIG. 4, but also other balancing circuits. At this time, the N battery cells are converted into the balanced state through (N−1) balancing operations, and the M battery modules are converted into the balanced state through (M−1) balancing operations.

According to the embodiment of the present invention, the battery module balancing method can balance the plurality of battery cells using a single inductor in each of the battery modules having modularized battery cells, and balance the plurality of modules using a single inductor. Thus, the battery module balancing method can reduce the number of balancing operations and raise the balancing power, thereby improving the balancing efficiency.

Furthermore, the battery module balancing method can perform balancing inside and outside the modules at the same time, the N battery cells perform (N−1) balancing operations, and the M modules perform (M−1) balancing operations. Therefore, all of the battery cells and the battery modules can accurately reach the balanced state within the shortest time.

While various embodiments have been described above, it will be understood to those skilled in the art that the embodiments described are by way of example only. Accordingly, the disclosure described herein should not be limited based on the described embodiments.

What is claimed is:

1. A battery module balancing method using a single inductor, comprising the steps:
(a) preparing a battery module pack having M battery modules connected in series, a first access unit configured to access electrical energy of the battery modules, and a first electrical energy transfer unit having a first single inductor and transfer paths between the first access unit and the first single inductor in order to temporarily store the electrical energy accessed through the first access unit and transfer the temporarily stored electrical energy, wherein each of the battery modules has N battery cells connected in series, and includes a second access unit, a second single inductor Ls and a second electrical energy transfer unit, which are coupled to the respective battery cells through the same coupling structure as the first access unit, the first single inductor and the first electrical energy transfer unit;
(b) measuring charges of all the battery cells in the battery modules once, checking whether a balancing operation condition is satisfied, sorting the charges of the battery cells when the balancing operation condition is satisfied, and calculating a target balanced charge on which the charges of the battery cells in the battery modules are to converge;
(c) sorting balanced charges of the battery modules, and calculating a target balanced charge on which the charges of the battery modules are to converge;
(d) selecting a strong cell and weak cell in the battery modules, and repetitively performing a balancing operation through the second access unit and the second electrical energy transfer unit, until the charges of the strong cell and the weak cell reach the target balanced charge on which the charges of the battery cells are to converge; and
(e) selecting a strong module and weak module in the battery modules, and repetitively performing a balancing operation through the first access unit and the first electrical energy transfer unit, until the charges of the strong module and the weak module reach the target balanced charge on which the charges of the battery modules are to converge,
wherein the balancing operation is performed inside and outside the modules at the same time, the N battery cells perform (N−1) balancing operations, and the M modules perform (M−1) balancing operations.

2. The battery module balancing method of claim 1, wherein the step (b) comprises comparing the charges of the battery cells in the battery modules to a threshold standard deviation, and proceeding to an idle mode or balancing operation mode depending on the comparison result.

3. The battery module balancing method of claim 1, wherein the step (b) comprises:
sorting the charges of the battery cells in the battery modules by descending order;
calculating the charges of the battery cells while increasing n one by one, and setting the target balanced charge on which the charges of the battery cells in the corresponding battery module are to converge, based on the calculation result; and
setting the target balanced charges on which the charges of the battery cells are to converge, in the battery modules in parallel.

4. The battery module balancing method of claim 1, wherein the step (c) comprises:
sorting the charges of the battery modules by descending order; and
calculating the charges of the battery modules while increasing n one by one, and setting the target balanced charge on which the charges of the battery modules are to converge, based on the calculation result.

5. The battery module balancing method of claim 1, wherein the step (d) comprises:
selecting the strong cell and the weak cell in the battery modules based on the target balanced charge on which the charges of the battery cells are to converge; and
setting a balancing time to perform a balancing operation.

6. The battery module balancing method of claim 5, wherein the balancing time is calculated by dividing a total amount of charge to be transferred by a received average current.

7. The battery module balancing method of claim 1, wherein the step (d) comprises:
calculating the charges of the strong cell and the weak cell after the balancing operation;
sorting the charges of the battery cells by a descending order; and
repetitively performing the balancing operation when a charge difference between the strong cell and the weak cell is equal to or more than a preset value, and returning to the initial state when the charge difference is less than the preset value.
